(19) United States
(12) Patent Application Publication
(10) Pub. No.: US 2026/0227545 A1
(43) Pub. Date: Aug. 6, 2026

(54) SYSTEM AND METHOD FOR CALIBRATING THROUGH-CASING ELECTROMAGNETIC INSTRUMENTS

(71) Applicants: CHINA PETROLEUM & CHEMICAL CORPORATION, Beijing (CN); ZHONGYUAN OILFIELD COMPANY, CHINA PETROLEUM & CHEMICAL CORPORATION, Puyang, Henan (CN)

(72) Inventors: Fei XU, Puyang, Henan (CN); Xili XI, Puyang, Henan (CN); Hua HUANG, Puyang, Henan (CN); Yongjun ZHANG, Puyang, Henan (CN); Kunpeng WEI, Puyang, Henan (CN); Lianbin XIE, Puyang, Henan (CN); Xiaomiao YOU, Puyang, Henan (CN); Qing LUO, Puyang, Henan (CN)

(21) Appl. No.: 19/125,818

(22) PCT Filed: Oct. 26, 2023
(86) PCT No.: PCT/CN2023/126852

§ 371 Date: Apr. 30, 2025

(30) Foreign Application Priority Data
Oct. 31, 2022 (CN) 202211351423.9

(51) Int. Cl. G01V 13/00; G01V 3/30; G01V 3/38

(52) U.S. Cl. CPC G01V 13/00; G01V 3/30; G01V 3/38

(57) ABSTRACT

A calibration system for a through-casing electromagnetic instrument, includes a casing; multiple coils wound outside the casing for simulating the resistivities of different depth formations respectively when one or more current or voltage signals are applied; a transmitter connected to the multiple coils and configured to provide the voltage or current signal to each of the multiple coils based on a control signal; and a control system in communication with the transmitter. The control system is configured to: generate the control signal based on a resistivity corresponding to the formation and a radial detection range to be simulated; and send the control signal to the transmitter so that the transmitter generates the voltage or current signal based on the control signal. A method for calibrating a through-casing electromagnetic instrument, a control system, a machine-readable storage medium, and a computer program product are also provided.

### TECHNICAL FIELD

The embodiment of this disclosure belongs to the field of oil and gas well logging engineering, and specifically relates to a system and method for calibrating through-casing electromagnetic Instruments.

### BACKGROUND

Induction logging is a logging method that studies the electrical conductivity of rock formations using the principle of electromagnetic induction. The output value of α logging instrument generally represents the measured resistivity of the formation. The formation resistivity can be used to evaluate the water flooded degree of oil and gas layers, determine the remaining oil saturation in reservoirs, monitor the changes in fluid saturation, search for remaining oil-enriched areas, and guide the further adjustment and development of oil and gas fields. Therefore, the accuracy of the output values of induction or electromagnetic logging instruments is of great significance, and various measures must be taken to ensure that the instruments output the true formation resistivity during logging engineering.

To make the actually measured formation resistivity data accurate and reliable, it is crucial to perform fine calibration and verification on electromagnetic logging instruments. Existing electromagnetic wave resistivity instruments usually follow the calibration method of cable logging resistivity instruments, placing the instrument in an open-air large-diameter brine tank. The resistivity of the brine in the tank is changed to simulate formation changes for instrument calibration. This calibration tank is large in volume, complex to manufacture, and strict in calibration operation, which is not conducive to daily, pre-logging, or post-logging calibration and verification of the instrument. Some companies use indoor calibration and verification devices, which are electronic formation simulators. The principle of this formation simulation device is to simulate the attenuation of electromagnetic wave signals by the formation through the attenuation of electromagnetic wave signals by electronic components, and it only conducts debugging and inspection on the antenna and circuit parts of the instrument, and cannot perform overall calibration and verification on the electromagnetic wave resistivity instrument.

The Chinese patent application with the publication number CN 107956466A discloses a calibration device for a transient electromagnetic resistivity logging instrument. When calibrating the logging instrument, distilled water is added to one of its internal cavities, and electrolyte salt is gradually added to another internal cavity. The true values of resistivity data are obtained through multiple experiments, thereby calibrating the measured engineering values of the logging instrument each time, and then obtaining the engineering value coefficient of the transient electromagnetic resistivity logging instrument to achieve the calibration of the logging instrument. However, this calibration device cannot perform layered simulation, and manual addition of electrolyte salt is required to change the resistivity values in each cavity, resulting in a cumbersome operation process.

The Chinese patent application with the publication number CN112034532A discloses a segmented experimental calibration device. This calibration device fills containers connected in series with brine of different resistivities to achieve layered simulation. However, this calibration device still requires manual addition of salt to change the resistivity values in each container, resulting in relatively cumbersome operation.

The Chinese patent application with the publication number CN103015970A discloses a simulation detection device for a logging-while-drilling resistivity logging instrument. In this device, the coupling coil conducts signal transmission with the logging-while-drilling resistivity logging instrument through electromagnetic coupling, and the receiving module receives the signal emitted by the logging-while-drilling resistivity logging instrument through the coupling coil; the formation simulation processing module performs amplitude adjustment and phase adjustment on the signal emitted by the logging-while-drilling resistivity logging instrument and obtains the correspondence between the amplitude attenuation value of the signal emitted by the logging-while-drilling resistivity logging instrument and the resistivity of formations at different detection depths, as well as the correspondence between the phase difference of the signal emitted by the logging-while-drilling resistivity logging instrument and the resistivity of formations at different detection depths; the transmitting module uses the coupling coil to emit response signals simulating formations with different resistivities that are coupled to the receiving coil of the logging-while-drilling resistivity logging instrument. The technical solution in this patent application has many disadvantages. First, to calibrate the logging instrument, the simulation detection device (or calibration system) needs to receive the signal emitted by the logging instrument, and then this simulation detection device adjusts the amplitude and phase of the received signal to simulate the response of the formation resistivity to signal from the logging instrument. Finally, the adjusted signal is transmitted back to the logging instrument for processing. This measurement process is complex and requires a large amount of calculation. Moreover, the calibration process is based on the signal emitted by the logging instrument, so this calibration process is affected by the emitted signal, and it is difficult to achieve calibration when the formation resistivity is greater than 10 ohm-meters. Second, in the technical solution of this patent application, the coupling coil is fixedly installed on the drill collar, resulting in an inability to relatively drag between the logging instrument and the simulation detection device, and unable to perform drag-layered calibration, that is, unable to perform layered calibration in the different formation depths. Third, in the technical solution of this patent application, multiple receiving coils are used to receive signals from the logging instrument to simulate resistivity responses at different depths (note: different depths here refer to detections in different lateral ranges (or radial ranges) at the same formation depth), such as ultra-shallow detection, shallow detection, medium detection, and deep detection. These multiple coils make the device structure complex and increase the cost.

### SUMMARY OF THE INVENTION

An object of the embodiment of the disclosure is to provide a calibration system, method, control system, storage medium, and computer program product for through-casing electromagnetic instruments (such as logging instruments) to solve at least one of the defects existing in the above-mentioned prior art. Another object of the embodiment of the disclosure is to reduce environmental noise interference and make the calibration results more accurate.

According to the first aspect of the present disclosure, a calibration system for a through-casing electromagnetic instrument is provided, comprising:
a casing, which is hollow and structured to hold the electromagnetic instrument;
multiple coils wound outside the casing, wherein the multiple coils are arranged side by side and have a certain distance from each other for simulating the resistivities of different depth formations respectively when one or more current or voltage signals are applied; wherein the adjacent coils of the multiple coils are configured to simulate the resistivities of adjacent formations at different depths;
a transmitter, connected to the multiple coils, and configured to provide the voltage or current signal to each of the multiple coils based on a control signal; and
a control system, communicated with the transmitter, wherein the control system is configured to:
   generate the control signal based on a resistivity corresponding to the formation and a radial detection range to be simulated; and
   send the control signal to the transmitter so that the transmitter generates the voltage or current signal based on the control signal.

Further, generating the control signal based on the resistivity corresponding to the formation and the radial detection range to be simulated comprises:
calculating the voltage signal Y to be generated by the transmitter: Y=A×sin (2παt), wherein A is a parameter corresponding to the resistivity of the formation to be simulated, α is the frequency of the voltage signal Y, the value of α is related to the radial detection range of the electromagnetic instrument to be simulated, and t is time; and
generating the control signal based on the voltage signal Y.
in addition, the calibration system for a through-casing electromagnetic instrument further comprises a receiver connected to the multiple coils and the control system, and configured to receive signals from the multiple coils and send the received signals to the control system.
further, the control system is further configured to:
put the calibration system in the background noise measurement mode;
receive, through the receiver, the background voltage signal B induced by the multiple coils in case that the transmitter does not provide voltage or current signals to the multiple coils; and
eliminate the influence of background noise by superposing a value with equal amplitude and opposite phase to the background voltage signal B when generating the control signal based on the resistivity corresponding to the formation and the radial detection range to be simulated.

Further, eliminating the influence of background noise comprises:
calculating the voltage signal Y to be generated by the transmitter: Y=A×sin (2παt)−B, where A is a parameter corresponding to the resistivity of the formation to be simulated, α is the frequency of the voltage signal Y, the value of α is related to the radial detection range of the electromagnetic instrument to be simulated, B is the background voltage signal, and t is time; and
generating the control signal based on the voltage signal Y.

Further, α increases or decreases in a certain pattern with a certain step size to simulate different radial detection ranges of the electromagnetic instrument.

Further, α performs a frequency sweep with a step size of 10 Hz in the range of 10 Hz-1000 Hz. Further, the number of the multiple coils in the calibration system for a through-casing electromagnetic instrument is an odd number greater than 2.

Further, the control system is further configured to:
put the calibration system in the integrity analysis mode;
send a control signal to the transmitter so that the transmitter provides the voltage signal Y to the multiple coils;
obtain, from the receiver, a response voltage signal Y1 of the electromagnetic instrument to the voltage signal Y; and
perform signal integrity analysis based on the voltage signal Y and the voltage signal Y1.

The second aspect of the present disclosure provides a method for calibrating a through-casing electromagnetic instrument, comprising:
obtaining, by a control system, the resistivity corresponding to the formation to be simulated;
generating, by the control system, a control signal based on the resistivity corresponding to the formation and a radial detection range to be simulated; and
sending, by the control system, the control signal so that the transmitter generates a voltage or current signal based on the control signal;
where the voltage or current signal is to be input into multiple side-by-side arranged coils so that the multiple coils simulate the resistivities of different depth formations, wherein the multiple coils are wound outside the casing and arranged side by side with a certain distance from each other, wherein the multiple coils are structured to simulate the resistivities of different depth formations respectively when the current or voltage is applied and the adjacent coils of the multiple coils are structured to simulate the resistivities of adjacent formations at different depths.

Further, according to the method above, generating the control signal by the control system based on the resistivity corresponding to the formation and the radial detection range to be simulated comprises:
calculating the voltage signal Y to be generated by the transmitter: Y=A×sin (2παt), wherein A is a parameter corresponding to the resistivity of the formation to be simulated, α is the frequency of the voltage signal Y, the value of α is related to the radial detection range of the electromagnetic instrument to be simulated, and t is time; and
generating the control signal based on the voltage signal Y.

Further, the method further comprising:

Further, according to the method, receiving, by the control system from the receiver, the background voltage signal B induced by the multiple coils in case that the control system does not sent the control signal to the transmitter such that the transmitter does not provide voltage or current signals to the multiple coils; and eliminating the influence of background noise by superposing a value with equal amplitude and opposite phase to the background voltage signal B when generating the control signal based on the resistivity corresponding to the formation and the radial detection range to be simulated.

Further, according to the method, eliminating the influence of background noise comprises:
calculating the voltage signal Y to be generated by the transmitter: Y=A×sin (2παt)−B, where A is a parameter corresponding to the resistivity of the formation to be simulated, α is the frequency of the voltage signal Y, the value of α is related to the radial detection range of the electromagnetic instrument to be simulated, B is the background voltage signal, and t is time; and
generating the control signal based on the voltage signal Y.

Further, according to the method, the control system is further configured to:
send a control signal to the transmitter so that the transmitter provides the voltage signal Y to the multiple coils;
obtain, from the receiver connected to the multiple coils, a response voltage signal Y1 of the electromagnetic instrument to the voltage signal Y; and
perform signal integrity analysis based on the voltage signal Y and the voltage signal Y1.

The third aspect of the present disclosure provides a control system comprising:
a processor, and
a computer-readable storage medium, including a computer program stored thereon, wherein the computer program includes executable instructions, which, when executed by the processor, implements the method according to the second aspect of the present disclosure.

The fourth aspect of the present disclosure provides a machine-readable storage medium, including a computer program stored thereon, wherein the computer program includes executable instructions, which, when executed by the processor, implements the method according to the second aspect of the present disclosure.

The fourth aspect of the present disclosure provides a computer program product, including a computer program, wherein the computer program includes executable instructions, which, when executed by the processor, implements the method according to the second aspect of the present disclosure.

In each embodiment of the present disclosure, the calibration system adjusts the voltage signals representing different resistivities via the control system, enabling multiple coils outside the casing to simulate and transmit different electromagnetic signals to simulate the formation resistivity. When the calibration system uses one coil to simulate the target formation and uses the adjacent coils to simulate the surrounding rock formations, the logging instrument in the casing can collect the formation resistivity signal affected by the surrounding rock formations. The logging instrument can be dragged and make measurement in the casing to perform layered calibration of the logging instrument. Compared with the calibration devices for electromagnetic instruments in the prior art, in the technical solution of the embodiment of present disclosure, during calibration, only the control system needs to control the transmitter to transmit voltage signals representing or corresponding to different resistivities, and the logging instrument does not need to transmit any signals. That is to say, in the technical solution of the embodiment of the present disclosure, the calibration system directly simulates the formation resistivity instead of simulating the response of different formation resistivities to the signal transmitted by the logging instrument. This makes it unnecessary for the logging instrument to transmit signals, and the calibration system does not need to process the signals transmitted by the logging instrument. Moreover, the calibration system in the embodiment of present disclosure can simulate different radial detection ranges of the logging instrument through a single coil, with a simpler structure. Therefore, the technical solution of the embodiment of the present disclosure has a small amount of calculation, simplifies the measurement steps, reduces errors, and is more accurate.

### BRIEF DESCRIPTION OF THE DRAWINGS

The drawings illustrate various examples of the aspects of the present disclosure, and they are used together with the description to explain the principles of the present disclosure. Those skilled in the art understand that the specific embodiments shown in the drawings are exemplary and do not intend to limit the scope of the present disclosure. It should be recognized that in some examples, one element can also be designed as multiple separated elements, or multiple elements can be combined into one element. In some examples, an element shown as an internal component of another element can also be implemented as an external component of that other element, and vice versa. In the drawings:

FIG. 1 is a structural schematic diagram of a calibration system for a through-casing electromagnetic instrument according to an embodiment of the present disclosure;

FIG. 2 is a schematic diagram of reducing environmental noise by applying the equal-amplitude and opposite-phase superposition method according to an embodiment of the present disclosure;

FIG. 3 is a flowchart of a method for calibrating a through-casing electromagnetic instrument according to an embodiment of the present disclosure;

FIG. 4 is a flowchart of a method for performing integrity analysis on an electromagnetic instrument according to an embodiment of the present disclosure;

FIG. 5 is a structural diagram of a control system according to an embodiment of the present disclosure.

### DETAILED DESCRIPTION

The following provides a detailed description of the specific implementation of the embodiments of the present disclosure in conjunction with the drawings. It should be understood that the specific implementation described herein is only used to illustrate and explain the embodiments of the present disclosure and is not used to limit the present disclosure.

As used hereinafter, the terms “have”, “include”, or “comprise” or any grammatical variants thereof are used in a non-exclusive manner. Therefore, in addition to the features introduced by these terms, these terms can refer to both the situation where there are no other features in the entity described in this context and the situation where there are one or more other features. For example, the expressions “A has B”, “A includes B”, and “A comprises B” can refer to both the situation where there are no other elements in A except B (that is, the situation where A consists only of B), and the situation where there are one or more other elements (such as element C, elements C and D, or even other elements) in entity A in addition to B.

In addition, it should be noted that terms such as “at least one”, “one or more”, or similar expressions indicating that a feature or element can exist once or more than once are usually only used once when introducing the feature or element firstly. In the following text, in most cases, when referring to the corresponding feature or element, although the corresponding feature or element can exist once or more than once, the expressions “at least one” or “one or more” will not be repeated.

In addition, as used hereinafter, terms such as “preferably”, “more preferably”, “particularly”, “more particularly”, “specifically”, “more specifically”, or similar terms are used in combination with optional features without limiting alternative possibilities. Therefore, the features introduced by these terms are optional features and are not intended to limit the scope of the claims in any way. As those skilled in the art will recognize, the present disclosure can be implemented by using alternative features. Similarly, the features introduced by expressions such as “in an embodiment of the present disclosure” or similar expressions are intended to be optional features, without any limitation to the alternative embodiments of the present disclosure, without any limitation to the scope of the present disclosure, and without any limitation to the possibility of combining the features introduced in this way with other optional or non-optional features of the present disclosure.

It will also be understood that although terms such as “first”, “second”, etc. can be used herein to describe various elements, these elements should not be limited by these terms. These terms do not represent an order but are only used to distinguish one element from another.

Now, referring to FIG. 1, a calibration system for a through-casing electromagnetic instrument is shown. The electromagnetic instrument is, for example, an electromagnetic logging instrument, which can also be simply referred to as a logging instrument. This calibration system includes a control system 11, a transmitter 12, a receiver 13, a casing 14, and multiple coils 15 wound around and outside the casing 14. The transmitter 12 can be, for example, a multi-channel transmitter for corresponding to the multiple coils 15, and the receiver 13 can be, for example, a multi-channel receiver for corresponding to the multiple coils 15. In addition, in an alternative embodiment, the transmitter 12 and the receiver 13 can be combined into one transceiver device, like a multi-channel transceiver device. As shown in FIG. 1, the casing 14 includes a hollow structure. During the calibration process, the hollow structure is used to hold the logging instrument. The multiple coils 15 are arranged side by side with a certain distance between each other. They are designed to simulate the resistivities of different formations when an electric current or voltage is applied to them. Specifically, based on the structure of the formation, the number of turns of the coils 15 and the distance between the coils can be adjusted. For instance, as the depth of the formation increases, the distance between the respective coils used to simulate each formation may increase. However, the distance between the respective coils can also be set to be the same. In this embodiment, a support frames 16 are respectively installed at both ends of the casing 14 to facilitate the horizontal placement of the casing 14. When performing calibration, the horizontal direction of the casing 14 corresponds to the depth direction of the formation.

In FIG. 1, the transmitter 12 is connected to the multiple coils 15 and the control system 11, and the receiver 13 is also connected to the multiple coils 15 and the control system 11. According to the formation structure to be simulated, the number of the multiple coils 15 can be odd numbers such as three, five, seven, or nine. This design can further ensure the accuracy of the calibration results.

In this embodiment, the calibration system can operate in different modes. When the calibration system is in the calibration mode, the control system 11 is configured to obtain one or more resistivities corresponding to the formation structure from a database storing formation data; generate a control signal based on the one or more resistivities; and then, send the control signal to the transmitter 12. The transmitter 12 is configured to generate a corresponding voltage or current signal according to the control signal and transmit the voltage or current signal to each of the coils 15. After receiving the voltage or current signal, each coil 15 generates an electromagnetic signal to simulate the respectively resistivities of different formation structures. The control system 11 can adjust the control signal to adjust the different voltage or current signals generated by the transmitter 12, and thus enable each coil 15 to simulate the resistivities or the electromagnetic signal of different formations (the resistivities of different formations and the electromagnetic signals of different formations are synonymous and can be used interchangeably herein). In the following description, for simplicity, the signals provided to the transmitter 12 or received from the receiver 13 are exemplified by voltage signals. However, those skilled in the art should understand that current signals can also be used to solve the technical problems.

In the embodiment of the present disclosure, the calibration system adjusts the voltage signals representing different resistivities by virtue of the control system 11, enabling the multiple coils 15 outside the casing 14 to transmit different electromagnetic signals in a simulated manner to simulate the formation resistivities. When the calibration system uses one coil to simulate the target formation and the adjacent coils to simulate the surrounding rock formations (the formations adjacent to the target formation are called surrounding rock formations), the logging instrument inside the casing 14 can collect the formation resistivity signal affected by the surrounding rock formations. By dragging the logging instrument inside the casing 14 for measurement, layered calibration of the logging instrument can be achieved. Compared with the calibration devices for electromagnetic instruments in the prior art, in the technical solution of the present disclosure, during calibration, only the control system 11 needs to control the transmitter 12 to transmit voltage signals representing or corresponding to different resistivities. The logging instrument does not need to emit electromagnetic signals. In other words, in the technical solution of the present disclosure, the calibration system directly simulates the formation resistivities instead of simulating the response of different formation resistivities to the signal transmitted by the logging instrument. This eliminates the need for the logging instrument to transmit electromagnetic signals and for the calibration system to process the electromagnetic signals transmitted by the logging instrument. Therefore, the technical solution of the present disclosure has a smaller amount of calculation, simplifies the measurement steps, reduces errors, and is more accurate.

The diameter of the casing 14 can be, for example, 5½ inches or 7 inches, and the length of the casing 14 is greater than that of the electromagnetic logging instrument. The support frame 16 is made of a material that is non-magnetic and non-conductive. During calibration, the electromagnetic logging instrument is placed inside the casing 14, and the coils 15 wound outside the casing 14 can transmit and receive different electromagnetic signals in a simulated manner. When performing calibration, the horizontal direction of the casing 14 corresponds to the depth direction of the formation.

Continuing to refer to FIG. 1, the receiver 13 is connected to the multiple coils 15 and the control system 11. The receiver 13 is configured to receive the voltage signals induced by the multiple coils 15 and transmit these signals to the control system 11 for further processing. Through the receiver 13, the control system can conduct environmental noise measurement and signal integrity analysis.

In the present disclosure, environmental noise refers to the background electromagnetic field noise existing in the environment around the calibration system in the absence of any intentional input from the logging instrument and the transmitter 12, also known as background noise. This noise can affect the accuracy of the calibration measurement. When conducting background noise measurement, the calibration system is in the background noise measurement mode. At this time, the electromagnetic logging instrument inside the casing 14 neither transmits nor collects signals, and the transmitter 12 of the calibration system does not provide any electrical signals to the multiple coils 15. At this moment, the multiple coils 15 generate a background voltage signal B through electromagnetic induction, which is then transmitted to the control system 11 via the receiver 13, or the control system 11 directly receives the background voltage signal B. The control system 11 stores this voltage signal B (such as in a memory) and superimposes the background voltage signal B with an equal-amplitude and opposite-phase value when generating the control signal based on the resistivity corresponding to the formation structure, in order to reduce environmental interference.

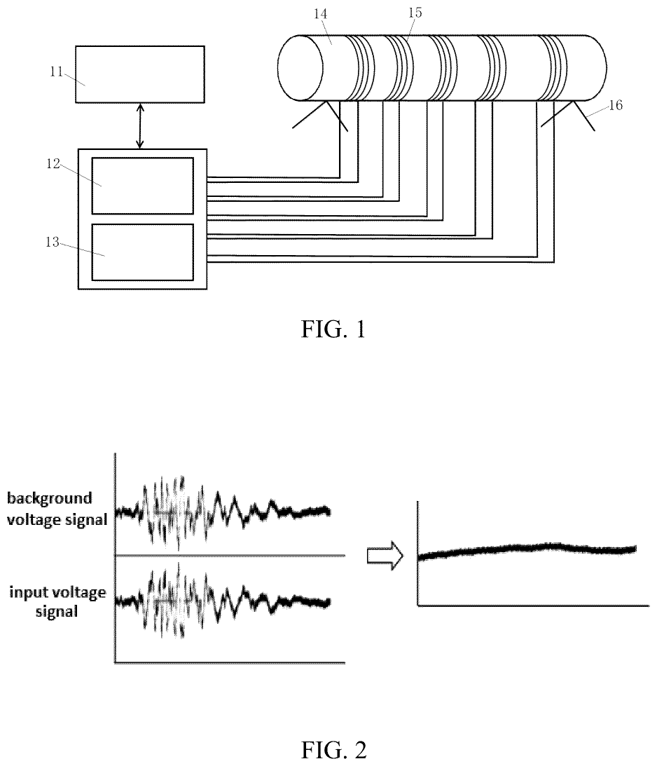

The principle of reducing environmental interference is shown in FIG. 2. By adding to the input voltage signals of each coil 15 a signal of an equal-amplitude and opposite phase to the background voltage signal B, the environmental interference is removed.

In addition, the control system 11 can perform signal integrity analysis through the receiver 13 to detect whether there are any faults in the logging instrument. When the calibration system is in the integrity analysis mode, signal integrity analysis can be carried out on the electromagnetic instrument. The steps of signal integrity analysis are as follows. The control system 11 sends a control signal to the transmitter 12. The transmitter 12 receives the control signal and generates a voltage signal Y based on the control signal, and provides the voltage signal Y to the multiple coils 15. The multiple coils 15 convert the voltage signal Y into different electromagnetic signals. At this time, as a result of the different electromagnetic signals, the electromagnetic logging instrument inside the casing 14 measures and obtains a formation voltage signal T. Then, the electromagnetic logging instrument inside the casing 14 transmits the voltage signal T, causing the multiple coils 15 of the calibration system to generate a voltage signal Y1 through electromagnetic induction, which is then transmitted to the control system 11 via the receiver 13. The control system 11 adjusts the control signal to make the transmitter 12 send different voltage signals to the multiple coils. The logging instrument measures and obtains different voltage signals and transmits them in reverse. Finally, the control system 11 receives multiple different voltage signals Y1. After repeating this process multiple times, the control system analyzes the relationship between the voltage signal Y and the voltage signal Y1, such as a linear relationship, to complete the signal integrity analysis and thereby determine whether there are any faults in the logging instrument.

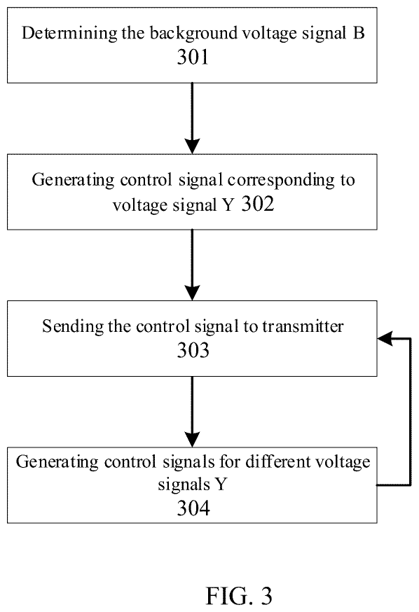

Next, referring to FIG. 3, it shows the flowchart of the method for calibrating a through-casing electromagnetic instrument according to an embodiment of the present disclosure.

At step 301, the background voltage signal B representing the background noise is determined. Specifically, at this time, the calibration system is in the background noise measurement mode. The electromagnetic logging instrument to be calibrated is placed inside the casing 14. The logging instrument does not transmit or collect signals, and the control system 11 also prohibits the transmitter 12 from providing any electrical signals to the coils 15. The multiple coils 15 generate the background voltage signal B through electromagnetic induction, which is then transmitted to the control system 11 via the receiver 13.

At step 302, the calibration system comes into the calibration mode. The control system 11 obtains the resistivity corresponding to the formation structure to be simulated from the formation database and calculates the voltage signal to be generated by the transmitter 12: Y=A×sin (2παt).
wherein A is a parameter corresponding to different formation resistivities stored in the formation database, which is obtained through experiments and stored in the database. Generally, the larger the resistivity of the formation, the smaller the value of A. α is the frequency of the voltage signal emitted by the transmitter. The value of α is variable. For example, the voltage signal performs a frequency sweep with a step size of 10 Hz in the range of 10 Hz-1000 Hz, that is, α increases or decreases in a certain pattern with a step size of 10 Hz. The value of α is related to the detection range or detection radius of the logging instrument to be simulated. When the value of α is small, the simulated detection radius is large. Conversely, as the value of α increases, the simulated detection radius becomes smaller. The value of a, the step size of increase or decrease, etc. are also obtained through experiments or experience. The t represents time.

It can be seen that in the present disclosure, by adjusting the frequency a of the above-mentioned voltage signal, the simulation of different detection ranges or radii can be achieved. Therefore, the calibration system in the present disclosure can simulate different radial detection ranges of the logging instrument through a single coil, without the need for multiple different coils, thus simplifying the structure and reducing the cost.

In addition, in order to reduce the impact of environmental noise, when determining the voltage signal in step 302, optionally, the impact of environmental noise can also be removed by superimposing a value with an equal amplitude and opposite phase to the background voltage signal. In this case, the voltage signal Y can be expressed as: Y=A×sin (2παt)−B, where B is the background voltage signal obtained in step 301. Then, the control system 11 generates a control signal based on the obtained voltage signal Y.

Next, the method proceeds to step 303. The control system 11 sends a control signal for the voltage signal Y to the transmitter 12. After receiving the control signal, the transmitter 12 generates the voltage signal Y and provides it to the multiple coils 15. After the voltage signal Y is applied to the multiple coils 15, different electromagnetic signals will be induced to simulate the formation resistivity. When the calibration system uses one coil to simulate the target formation and the adjacent coils to simulate the surrounding rock formations, the logging instrument at the corresponding position inside the casing can collect the formation voltage signal T affected by the surrounding rock formations.

Finally, at step 304, the control system adjusts the voltage signal Y representing different resistivity formations. The multiple coils 15 generate electromagnetic signals simulating different resistivity formations to achieve the calibration of the logging instrument.

The calibration data is shown in Table 1 below. It can be seen from the data in Table 1 that the measurement error between the voltage Y simulating the formation resistivity (the peak value of voltage Y is listed in Table 1) and the formation voltage signal T collected by the logging instrument (the peak value of voltage signal T is listed in Table 1) is less than 5%, indicating that this calibration system can achieve the calibration of the through-casing electromagnetic instrument.

TABLE 1
Layered Calibration Data and Errors

| Serial | | | Relative |
|---|---|---|---|
| Number | Y (V) | T (V) | Error |
| 1 | 1.00 | 0.96 | 3.63% |
| 2 | 2.00 | 1.99 | 0.42% |
| 3 | 2.99 | 2.97 | 0.63% |
| 4 | 3.88 | 3.89 | −0.20% |
| 5 | 5.08 | 5.12 | −0.77% |
| 6 | 6.18 | 6.09 | 1.46% |
| 7 | 7.47 | 7.51 | −0.50% |
| 8 | 8.22 | 8.50 | −3.40% |
| 9 | 9.14 | 9.34 | −2.22% |
| 10 | 9.96 | 9.53 | 4.39% |
| 11 | 12.00 | 12.02 | −0.19% |
| 12 | 14.98 | 14.99 | −0.09% |

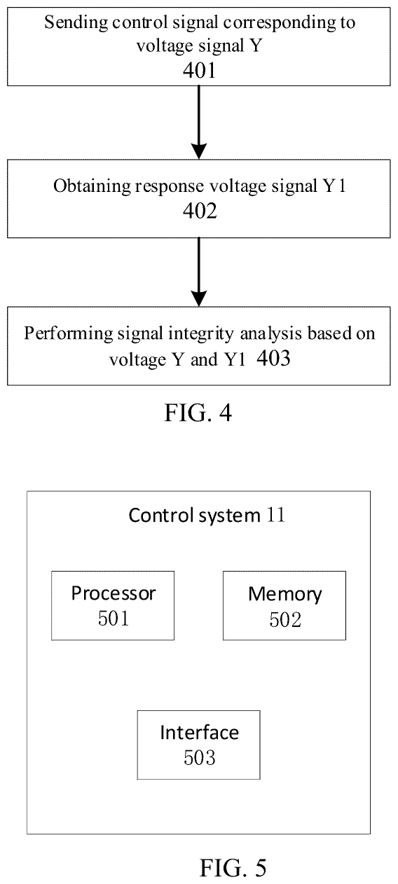

Now, referring to FIG. 4, it shows the flowchart of the method for performing integrity analysis on an electromagnetic instrument according to an embodiment of the present disclosure. Specifically, through the calibration system of the present disclosure, signal integrity analysis can be carried out on the electromagnetic instrument. At this time, the calibration system is in the integrity analysis mode.

First, at step 401, the control system 11 sends a control signal to the transmitter 12 to make the transmitter provide a voltage signal Y to the coil 15. The step is similar to steps 301 and 302, except that the voltage signal Y is not necessarily based on the resistivities of different formations in the formation database, as long as the voltage signal Y can continue the integrity analysis.

Then, at step 402, the response voltage signal Y1 is obtained from the receiver 13. The response voltage signal Y1 is the response of the logging instrument to the voltage signal Y. Specifically, after the multiple coils 15 receive the voltage signal Y via the transmitter 12, different electromagnetic signals will be induced in the coils 15. At this time, in response to those electromagnetic signals, the electromagnetic logging instrument at the corresponding position in the casing 14 can measure and obtain a voltage signal T. Then, the electromagnetic logging instrument emits the voltage signal T, for example, by generating a corresponding electromagnetic signal. The multiple coils 15 of the calibration system will generate the voltage signal Y1 through electromagnetic induction in response to the electromagnetic signal related to the voltage signal T from logging instrument and transmit it to the control system 11 via the receiver 13 to obtain the voltage signal Y1.

Steps 401 and 402 are performed iteratively. By the control system 11 adjusting the voltage signals representing different resistivities, the logging instrument measures and obtains different voltage signals T and emits electromagnetic signal in responses. The control system 11 receives different corresponding voltage signals Y1.

Finally, after obtaining a sufficient number of voltage signals Y and Y1, at step 403, based on the linear relationship between the voltage signal Y and the voltage signal Y1, signal integrity analysis is performed. Through integrity analysis, it can be determined whether there are any faults in the logging instrument.

Those skilled in the art can understand that the integrity analysis method in FIG. 4 can be combined with the calibration method in FIG. 3 to form a technical solution. In addition, the order of the method steps in FIGS. 3 and 4 does not necessarily need to be executed in the order shown in the figures. Even some steps can be executed simultaneously, or some steps can be omitted, as long as it does not conflict with the technical problems to be solved by the technical solution of the present disclosure.

Now, referring to FIG. 5, it further depicts the control system 11 in FIG. 1. Referring to FIG. 5, the control system 11 includes a processor 501, a memory 502, and an interface 503. The processor 501 realizes the operation of the control system 11 by executing the computer-executable instructions that define the methods shown in FIG. 3 or 4. A computer program product including computer-executable instructions can be stored in the memory 502. The methods described in FIGS. 3 and 4 can be defined by the computer-executable instructions included in the computer program product stored in the memory 502 and controlled by the processor 501 that executes these computer-executable instructions. The interface 503 can include a network interface for communicating with other devices via a network. This interface can also include other input/output devices (such as a display, keyboard, mouse, speaker, button, touchpad, touch screen, etc.) that enable users to interact with the control system 11. Those skilled in the art will recognize that the actual implementation of the control system may also include other components, and FIG. 5 is a high-level representation of some components of such a control system for illustrative purposes.

The memory 502 includes a tangible non-transient machine-readable storage medium. It can also include high-speed random-access memory, such as dynamic random-access memory (DRAM), static random-access memory (SRAM), double-data-rate synchronous dynamic random-access memory (DDR RAM), or other random-access solid-state memory devices. It can also include non-volatile memory, such as one or more disk storage devices (such as internal hard disks and removable disks), magneto-optical disk storage devices, optical disk storage devices, flash memory devices, semiconductor memory devices (such as erasable programmable read-only memory (EPROM), electrically erasable programmable read-only memory (EEPROM)), compact disc read-only memory (CD-ROM), digital versatile disc read-only memory (DVD-ROM) discs, or other non-volatile solid-state storage devices.

Through the above description, the calibration system for through-casing electromagnetic instruments proposed by the embodiments of the present disclosure is smaller in size and simpler to operate compared with the calibration devices for electromagnetic instruments in the prior art, which improves work efficiency. By superposing a value with an equal amplitude and opposite phase to the background voltage signal on the output voltage signal, environmental interference can be reduced. By adjusting the voltage signal instructions representing different conductivity formations through the control system, multiple coils outside the casing can transmit electromagnetic signals of different formations in a stimulated way, enabling layered calibration of the instrument. Moreover, there is no need for multiple coils to simulate the same formation depth, resulting in a simple structure. By comparing the signals transmitted and received between the logging instrument and the coils outside the casing, signal integrity analysis can be carried out.

It should be recognized that for the sake of clarity, certain features of the present disclosure described in the context of separate embodiments can also be provided in combination in a single embodiment. Conversely, for the sake of simplicity, various features of the present disclosure described in the context of a single embodiment can also be provided separately, in any suitable sub-combination, or in any other described embodiments of the present disclosure. Some features described in the context of various embodiments should not be considered essential features of those embodiments unless the embodiment is ineffective without those elements.

Although the present disclosure has been described in conjunction with specific embodiments of the present disclosure, it is obvious that many alternatives, modifications, and variations will be apparent to those skilled in the art in light of the disclosure. Therefore, it is intended to cover all such alternatives, modifications, and variations that fall within the spirit and broad scope of the appended claims.

All publications, patents, and patent applications mentioned in this specification are incorporated herein by reference in their entirety, to the extent as if each individual publication, patent, or patent application is specifically and particularly indicated to be incorporated by reference. In addition, the citation or identification of any reference in the present disclosure should not be construed as an admission that such reference can be used as prior art for the present disclosure. When using section headings, they should not be construed as necessarily restrictive.

1. A calibration system for a through-casing electromagnetic instrument, comprising:
a casing, which is hollow and structured to hold the electromagnetic instrument;
multiple coils wound outside the casing, wherein the multiple coils are arranged side by side and have a certain distance from each other for simulating the resistivities of different depth formations respectively when one or more current or voltage signals are applied; wherein the adjacent coils of the multiple coils are configured to simulate the resistivities of adjacent formations at different depths;
a transmitter, connected to the multiple coils, and configured to provide the voltage or current signal to each of the multiple coils based on a control signal; and
a control system, communicated with the transmitter, wherein the control system is configured to:
generate the control signal based on a resistivity corresponding to the formation and a radial detection range to be simulated; and
send the control signal to the transmitter so that the transmitter generates the voltage or current signal based on the control signal.

2. The calibration system for a through-casing electromagnetic instrument according to claim 1, wherein generating the control signal based on the resistivity corresponding to the formation and the radial detection range to be simulated comprises:
calculating the voltage signal Y to be generated by the transmitter: Y=A×sin (2παt), wherein A is a parameter corresponding to the resistivity of the formation to be simulated, α is the frequency of the voltage signal Y, the value of α is related to the radial detection range of the electromagnetic instrument to be simulated, and t is time; and
generating the control signal based on the voltage signal Y.

3. The calibration system for a through-casing electromagnetic instrument according to claim 1, further comprising:
a receiver, connected to the multiple coils and the control system, and configured to receive signals from the multiple coils and send the received signals to the control system.

4. The calibration system for a through-casing electromagnetic instrument according to claim 3, wherein the control system is further configured to:
put the calibration system in the background noise measurement mode;
receive, through the receiver, the background voltage signal B induced by the multiple coils in case that the transmitter does not provide voltage or current signals to the multiple coils; and
eliminate the influence of background noise by superposing a value with equal amplitude and opposite phase to the background voltage signal B when generating the control signal based on the resistivity corresponding to the formation and the radial detection range to be simulated.

5. The calibration system for a through-casing electromagnetic instrument according to claim 4, wherein eliminating the influence of background noise comprises:
calculating the voltage signal Y to be generated by the transmitter: Y=A×sin (2παt)−B, where A is a parameter corresponding to the resistivity of the formation to be simulated, α is the frequency of the voltage signal Y, the value of α is related to the radial detection range of the electromagnetic instrument to be simulated, B is the background voltage signal, and t is time; and
generating the control signal based on the voltage signal Y.

6. The calibration system for a through-casing electromagnetic instrument according to claim 2, wherein a increases or decreases in a certain pattern with a certain step size to simulate different radial detection ranges of the electromagnetic instrument.

7. The calibration system for a through-casing electromagnetic instrument according to claim 6, wherein a performs a frequency sweep with a step size of 10 Hz in the range of 10 Hz-1000 Hz.

8. The calibration system for a through-casing electromagnetic instrument according to claim 1, wherein the number of the multiple coils is an odd number greater than 2.

9. The calibration system for a through-casing electromagnetic instrument according to claim 3, wherein the control system is further configured to:
put the calibration system in the integrity analysis mode;
send a control signal to the transmitter so that the transmitter provides the voltage signal Y to the multiple coils;
obtain, from the receiver, a response voltage signal Y1 of the electromagnetic instrument to the voltage signal Y; and
perform signal integrity analysis based on the voltage signal Y and the voltage signal Y1.

10. A method for calibrating a through-casing electromagnetic instrument, comprising:
obtaining, by a control system, the resistivity corresponding to the formation to be simulated;
generating, by the control system, a control signal based on the resistivity corresponding to the formation and a radial detection range to be simulated; and
sending, by the control system, the control signal so that the transmitter generates a voltage or current signal based on the control signal;
where the voltage or current signal is to be input into multiple side-by-side arranged coils so that the multiple coils simulate the resistivities of different depth formations, wherein the multiple coils are wound outside the casing and arranged side by side with a certain distance from each other, wherein the multiple coils are structured to simulate the resistivities of different depth formations respectively when the current or voltage is applied and the adjacent coils of the multiple coils are structured to simulate the resistivities of adjacent formations at different depths.

11. The method according to claim 10, wherein generating the control signal by the control system based on the resistivity corresponding to the formation and the radial detection range to be simulated comprises:
calculating the voltage signal Y to be generated by the transmitter: Y=A×sin (2παt), wherein A is a parameter corresponding to the resistivity of the formation to be simulated, α is the frequency of the voltage signal Y, the value of α is related to the radial detection range of the electromagnetic instrument to be simulated, and t is time; and
generating the control signal based on the voltage signal Y.

12. The method according to claim 10, further comprising:
receiving, by the control system from the receiver, the background voltage signal B induced by the multiple coils in case that the control system does not sent the control signal to the transmitter such that the transmitter does not provide voltage or current signals to the multiple coils; and
eliminating the influence of background noise by superposing a value with equal amplitude and opposite phase to the background voltage signal B when generating the control signal based on the resistivity corresponding to the formation and the radial detection range to be simulated.

13. The method according to claim 12, wherein eliminating the influence of background noise comprises:
calculating the voltage signal Y to be generated by the transmitter: Y=A×sin (2παt)−B, where A is a parameter corresponding to the resistivity of the formation to be simulated, α is the frequency of the voltage signal Y, the value of α is related to the radial detection range of the electromagnetic instrument to be simulated, B is the background voltage signal, and t is time; and
generating the control signal based on the voltage signal Y.

14. The method according to claim 11, wherein the control system makes a increase or decrease in a certain pattern with a certain step size to simulate different radial detection ranges of the electromagnetic instrument.

15. The method according to claim 14, wherein a performs a frequency sweep with a step size of 10 Hz in the range of 10 Hz-1000 Hz.

16. The method according to claim 10, wherein the control system is further configured to:
send a control signal to the transmitter so that the transmitter provides the voltage signal Y to the multiple coils;
obtain, from the receiver connected to the multiple coils, a response voltage signal Y1 of the electromagnetic instrument to the voltage signal Y; and
perform signal integrity analysis based on the voltage signal Y and the voltage signal Y1.

17. A control system, comprising:
a processor, and
a computer-readable storage medium, including a computer program stored thereon, wherein the computer program includes executable instructions, which, when executed by the processor, implements the method according to claim 9.

18. A machine-readable storage medium, including a computer program stored thereon, wherein the computer program includes executable instructions, which, when executed by the processor, implements the method according to claim 9.

19. A computer program product, including a computer program, wherein the computer program includes executable instructions, which, when executed by the processor, implements the method according to claim 9.
